(19) United States
(12) Patent Application Publication
(10) Pub. No.: US 2025/0260292 A1
(43) Pub. Date: Aug. 14, 2025

(54) ELECTRIC MACHINE

(71) Applicant: AUDI AG, Ingolstadt (DE)

(72) Inventor: Tim VON HÖRSTEN, Lauffen (DE)

(21) Appl. No.: 19/047,409

(22) Filed: Feb. 6, 2025

(30) Foreign Application Priority Data
Feb. 8, 2024 (DE) 102024103523.4

(51) Int. Cl. H02K 5/24; H02K 1/278

(52) U.S. Cl. CPC H02K 5/24; H02K 1/278

(57) ABSTRACT

An electric machine is disclosed, and may include a rotor and a centrifugal pendulum. The rotor may have permanent magnets and a number of pole pairs. Magnetic fields of the permanent magnets may be aligned parallel to a rotor axis of rotation of the rotor The centrifugal pendulum may have a natural frequency and a pivot point which is attached to the rotor and is at a distance greater than zero from the rotor axis of rotation. The natural frequency of the centrifugal pendulum may be matched to the number of pole pairs of the permanent magnets of the rotor.

### BACKGROUND

### Technical Field

The disclosure relates to an electric machine and a vehicle.

### Description of the Related Art

A hybrid vehicle is known from the publication EP3461669A1.

A hybrid module for a vehicle is known from the publication DE102014222644A1.

A drive train for a hybrid drive is described in the publication DE102009012485A1.

The publication DE102018101597A1 describes a drive train for a means of transport.

Against this background, there exists a need to optimize an electric machine.

### BRIEF SUMMARY

The electric machine according to the present disclosure may have a rotor and a centrifugal pendulum as a damper, e.g., a vibration damper. The rotor may have a rotor axis of rotation, permanent magnets, and a number of pole pairs, wherein magnetic fields of the permanent magnets and/or the pole pairs generated by the magnetic fields and/or the pole pairs may be aligned at least along the rotor axis largely parallel to the rotor axis of rotation of the rotor. The centrifugal pendulum may have a natural frequency and a pivot point which is attached to the rotor. The pivot point may be at a distance greater than zero from the rotor axis of rotation, wherein a pendulum axis of the centrifugal pendulum running through the pivot point may be arranged offset parallel to the rotor axis of rotation. The natural frequency of the centrifugal pendulum may be matched to the number of pole pairs of the permanent magnets of the rotor or may correspond thereto.

The centrifugal pendulum may have a mass body and a connecting element, wherein the mass body may be attached to the pivot point on the rotor via the connecting element and is rotatable relative to the rotor, wherein the distance determined by way of a length of the connecting element. The natural frequency of the centrifugal pendulum may not be fixed, but may be matched to the number of pole pairs of the rotor.

The vehicle according to the, for example a motor vehicle, may have at least one embodiment of the electric machine presented. The electric machine may be configured to drive at least one device, for example at least one device of the vehicle and/or the entire vehicle, such as for drive wheels as devices of the vehicle. The vehicle may, as a hybrid vehicle, be driven or may be configured to be driven by at least one electric machine presented and another drive unit, for example an internal combustion engine. It is also possible for the vehicle to be driven or to be able to be driven as a pure electric vehicle only by at least one electric machine presented.

In some embodiments, the centrifugal pendulum may have a natural frequency that is matched to a specific nth order of the rotor speed, i.e., a rotational irregularity and/or torque ripple of the rotor shaft. This means that the natural frequency of the centrifugal pendulum may adaptively correspond to a number of pole pairs of the rotor and/or may be adaptively matched to the number of pole pairs. In some embodiments, a natural frequency of the rotor or of the rotor rotating about the rotor axis of rotation when the electric machine is operating may have at least one order that depends on the number of pole pairs. In this case, the natural frequency of the centrifugal pendulum may be selected as equal to the at least one order of the natural frequency of the rotor, such as in a speed-adaptive manner, wherein the at least one order of the natural frequency of the rotor can be canceled out by the centrifugal pendulum. The number of pole pairs, each consisting of a magnetic north pole and a magnetic south pole, may also correspond to a number of permanent magnets.

The electric machine may have permanent magnets and/or magnetic fields of the permanent magnets that are oriented or aligned straight or parallel to the rotor axis of rotation. For an electric machine that has a combination of the described rotor and the centrifugal pendulum provided, torsional vibrations of the rotor rotating during operation may be reduced by the centrifugal pendulum adapted to the rotor.

In contrast, in known electric machines, permanent magnets and/or magnetic fields are obliquely arranged to the rotor axis of rotation and overlap with respect to the rotor axis of rotation. The centrifugal pendulum, which may be matched to the number of pole pairs and may act as a speed-adaptive damper on and/or at the rotor of the electric machine, may enable a reduction of a cogging torque and/or torque ripple of the rotor. Here, lossy torque control over an angle of rotation of 360°, e.g., by an electrical circuit, such as an inverter, for speed-synchronous torque shafts, can be dispensed with, since rotations of the rotor may be automatically adjusted purely mechanically by the centrifugal pendulum during operation. Such a configuration can increase the efficiency and performance of the electric machine and of the vehicle it drives. The range of the electrically driven vehicle may be increased and comfort for the driver may be improved.

In an electric motor with one pole pair, the torque ripple may occur substantially with the first order of the rotor speed, wherein the natural frequency of the speed-adaptive centrifugal pendulum may be matched to the first order. In a configuration having four pole pairs, the torque ripple may occur substantially with the fourth order of the rotor speed, wherein the natural frequency of the speed-adaptive centrifugal may be matched to the fourth order.

In some embodiments, the electric machine may have a stator that encloses the rotor and the centrifugal pendulum attached to it, wherein the rotor rotates within the stator when the electric machine is operating. The stator may have several electromagnets that enclose the rotor. In such embodiments, the electromagnets and/or the magnetic fields they generate may also be oriented parallel to the rotor axis of rotation. The electric machine may be operated both as an electric motor and as an electric generator.

It should be understood that the features mentioned above and those to be explained below can be used not only in the combination specified in each case, but also in other combinations or on their own, without departing from the scope of the present disclosure.

### BRIEF DESCRIPTION OF THE SEVERAL VIEWS OF THE DRAWINGS

FIG. 1 shows a schematic representation of an electric machine according to the prior art.

FIG. 2a shows a side schematic representation of an embodiment of the electric machine according to the disclosure.

FIG. 2b shows a sectional schematic representation of the embodiment of the electric machine of FIG. 2a.

### DETAILED DESCRIPTION

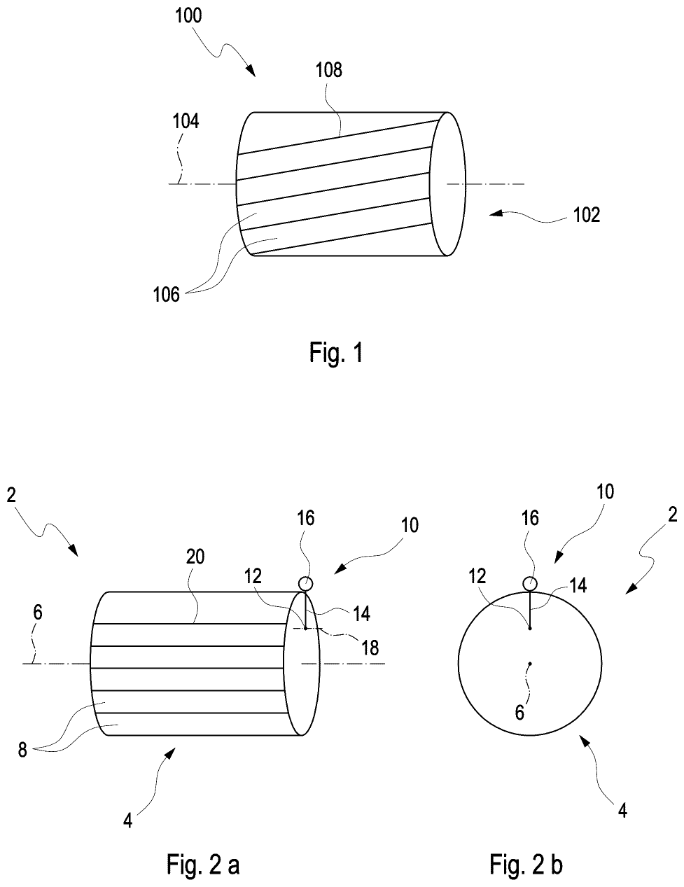

Electric machine 100 shown in FIG. 1 and known from the prior art comprises a rotor 102 which is rotatable about a rotor axis of rotation 104. Rotor 102 comprises a plurality of permanent magnets 106 which are aligned obliquely to the rotor axis of rotation 104, which is indicated here by lines 108.

The embodiment of electric machine 2 according to the present disclosure, shown schematically in FIG. 2a from a side perspective and in FIG. 2b in a sectional view, may comprise a rotor 4 with a number of permanent magnets 8 and a central rotor axis of rotation 6. In this embodiment, permanent magnets 8 and/or magnetic fields generated by the permanent magnets 8 may be aligned or oriented parallel to the rotor axis of rotation 6, at least along the rotor axis of rotation 6, which is indicated in FIG. 2a by lines 20.

In some embodiments, the electric machine 2 may additionally have a stator (not shown) comprising electromagnets, which may surround rotor 4. In such embodiments, the electromagnets and/or magnetic fields generated by the electromagnets may also be aligned or oriented parallel to rotor axis of rotation 6, at least along rotor axis of rotation 6.

In addition, rotor 4 may be combined with a centrifugal pendulum 10 acting as a mechanical damper, e.g., a vibration damper, for rotor 4. Centrifugal pendulum 10 may have a pivot point 12, which may be arranged on a permanent magnet 8 of rotor 4, with a position of pivot point 12 being located radially between central rotor axis of rotation 6 and an outer wall of permanent magnets 8. In addition, centrifugal pendulum 10 may have an elongated connecting element 14 and a mass body 16. Mass body 16 may be rotatably attached to pivot point 12 via connecting element 14.

When electric machine 2 is operating, rotor 4 may rotate relative to the stator. Connecting element 14 and mass body 16 may also be rotated about a pendulum axis of rotation 18, which runs through pivot point 12 and is aligned or oriented parallel to rotor axis of rotation 6.

A natural frequency of centrifugal pendulum 10 may be matched to and/or correspond to a number of pole pairs of permanent magnets 8 of rotor 4.

German patent application no. 102024103523.4 filed Feb. 8, 2024, to which this application claims priority, is hereby incorporated herein by reference, in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. An electric machine comprising:
a rotor having permanent magnets and a number of pole pairs, wherein magnetic fields of the permanent magnets are aligned parallel to a rotor axis of rotation of the rotor; and
a centrifugal pendulum having a natural frequency and a pivot point which is attached to the rotor and is at a distance greater than zero from the rotor axis of rotation,
wherein the natural frequency of the centrifugal pendulum is matched to the number of pole pairs of the rotor.

2. The electric machine according to claim 1, wherein the centrifugal pendulum has a mass body and a connecting element, wherein the mass body is fastened to the rotor at the pivot point via the connecting element, wherein the distance is determined in dependence on a length of the connecting element.

3. The electric machine according to claim 1, wherein the electric machine is configured to be used for a vehicle.

4. A vehicle having at least one electric machine comprising:
a rotor having permanent magnets and a number of pole pairs, wherein magnetic fields of the permanent magnets are aligned parallel to a rotor axis of rotation of the rotor; and
a centrifugal pendulum having a natural frequency and a pivot point which is attached to the rotor and is at a distance greater than zero from the rotor axis of rotation,
wherein the natural frequency of the centrifugal pendulum is matched to the number of pole pairs of the rotor.
